(19) United States
(12) Patent Application Publication
(10) Pub. No.: US 2026/0363527 A1
(43) Pub. Date: Nov. 19, 2026

(54) PORTABLE FOOTWEAR CLEANING APPARATUS WITH INTEGRATED WATER JET SYSTEM AND SCRAPING GRATE

(71) Applicant: Andrew Crandall, Hendersonville, NC (US)

(72) Inventor: Andrew Crandall, Hendersonville, NC (US)

(21) Appl. No.: 19/676,357

(22) Filed: May 13, 2026

Related U.S. Application Data
(60) Provisional application No. 63/835,045, filed on May 19, 2025.

(51) Int. Cl. A47L 23/24; A47L 23/02; B08B 3/02

(52) U.S. Cl. CPC A47L 23/24; A47L 23/02; B08B 3/02

(57) ABSTRACT

A portable footwear cleaning apparatus comprises a basin body defining an interior cavity, a scraping grate disposed at an upper region of the interior cavity, and a plurality of upwardly directed water jet nozzles mounted beneath the grate. A water distribution tube disposed proximate the floor region of the body fluidly connects a water inlet to the plurality of nozzles. A generally U-shaped handle extends upwardly from the body to provide balance support to a user during cleaning. The water inlet with a garden hose fitting, a flow control mechanism, and the water distribution tube provide selective delivery of pressurized water through the nozzles. In use, a user positions a boot on the grate, scrapes the sole against the grate to dislodge debris, and actuates the water jets to direct pressurized water upwardly against the sole and sidewall surfaces of the boot.

### RELATED APPLICATION

This application claims the benefit of U.S. Provisional Patent Application No. 63/835,045, filed May 19, 2025, the entire disclosure of which is hereby incorporated by reference herein.

### FIELD OF THE INVENTION

The present invention relates generally to footwear cleaning devices, and more particularly, to a portable apparatus configured to clean work boots and similar footwear using a combination of mechanical scraping and pressurized water jets.

### BACKGROUND

Workers in the construction, landscaping, agriculture, and utility industries frequently encounter muddy and debris-laden conditions that result in significant accumulation of soil, clay, and other contaminants on work boots. Upon transitioning from a job site to a vehicle or indoor environment, such contamination presents practical and sanitary concerns, including the soiling of vehicle interiors, floors, and other surfaces.

Existing approaches to cleaning work boots in the field are largely improvised and inefficient. Workers commonly resort to scraping boots against curbs, stomping on the ground, or rinsing boots with an uncontrolled garden hose. These ad hoc methods are time-consuming, often incomplete, and fail to adequately remove compacted mud or debris from the tread pattern of boot soles.

Certain fixed-installation boot wash stations exist in some industrial settings, such as food processing facilities. However, these installations are permanently mounted, require plumbing infrastructure, are not transportable, and are generally unsuitable for field use by tradespeople who move between multiple job sites throughout a workday.

There remains an unmet need for a self-contained, portable boot cleaning apparatus that can be readily transported to and between job sites, requires only a standard garden hose connection for water supply, and provides both mechanical scraping and pressurized water jet cleaning in a single, compact unit.

### SUMMARY

The present invention is directed to a portable footwear cleaning apparatus that addresses the aforementioned deficiencies in the art. The apparatus comprises a basin body defining an interior cavity, a removable grate positioned within the interior cavity, a plurality of upwardly directed water jet nozzles disposed beneath the grate, a handle extending upwardly from the body, a water inlet configured to couple to a standard garden hose, a flow control mechanism, and a water distribution tube fluidly connecting the water inlet to the plurality of nozzles.

In use, a user positions one boot at a time on the grate and may scrape the sole thereof against the grate surface to dislodge loose mud and debris mechanically. Upon actuation of the flow control mechanism, pressurized water is directed through the water distribution tube and the plurality of nozzles, which are oriented to project water upwardly through the grate openings against the sole and lower sidewall surfaces of the boot. The handle provides a stabilizing grip for the user during the cleaning operation.

The apparatus is configured to be portable and self-contained, requiring no permanent installation and no power source other than a pressurized water supply from a standard garden hose. A removable cover is provided to protect the interior components during transport and storage. The body, handle, and cover are each formed from a durable polymeric material, such as acrylonitrile butadiene styrene (ABS), using injection molding processes.

Advantages of the present invention include, but are not limited to: portability for use at multiple job sites; combined mechanical and hydraulic cleaning action; accommodation of a single boot at a time for thorough cleaning; user stability via the upstanding handle; compatibility with standard garden hose fittings; and ease of manufacture using injection molding techniques.

### BRIEF DESCRIPTION OF THE DRAWING

FIG. 1 is an exploded perspective view of the portable footwear cleaning apparatus according to an embodiment of the present invention, showing the handle, nozzles, water hose connector, body, and cover as separate components.

FIG. 2A is a top plan view of the body of the apparatus, showing the arrangement of nozzle mounting apertures, the scraping grate, and a section line A-A.

FIG. 2B is a cross-sectional view of the body taken along line A-A of FIG. 2A, showing the interior cavity, the floor region, the grate, and the plurality of nozzles.

FIG. 3A is a front elevational view of the handle, showing the U-shaped configuration thereof.

FIG. 3B is a side elevational view of the handle.

FIG. 4A is a top plan view of the cover, showing the planar configuration thereof.

FIG. 4B is a side elevational view of the cover, showing the thickness thereof.

FIG. 5 is a perspective view of the assembled apparatus in an operational configuration, showing a boot positioned on the grate with the water hose connected thereto.

FIG. 6 is a partial cutaway view of the apparatus, showing the interior arrangement of the plurality of nozzles beneath the grate, the water distribution tube, and the water flow pathways.

### DETAILED DESCRIPTION

The following detailed description is provided to enable a person having ordinary skill in the art to make and use the invention. Various modifications to the embodiments described herein will be apparent to those skilled in the art, and the general principles set forth herein may be applied to other embodiments without departing from the spirit and scope of the invention. The present invention is not intended to be limited to the embodiments shown and described, but is to be accorded the widest scope consistent with the principles and novel features disclosed herein.

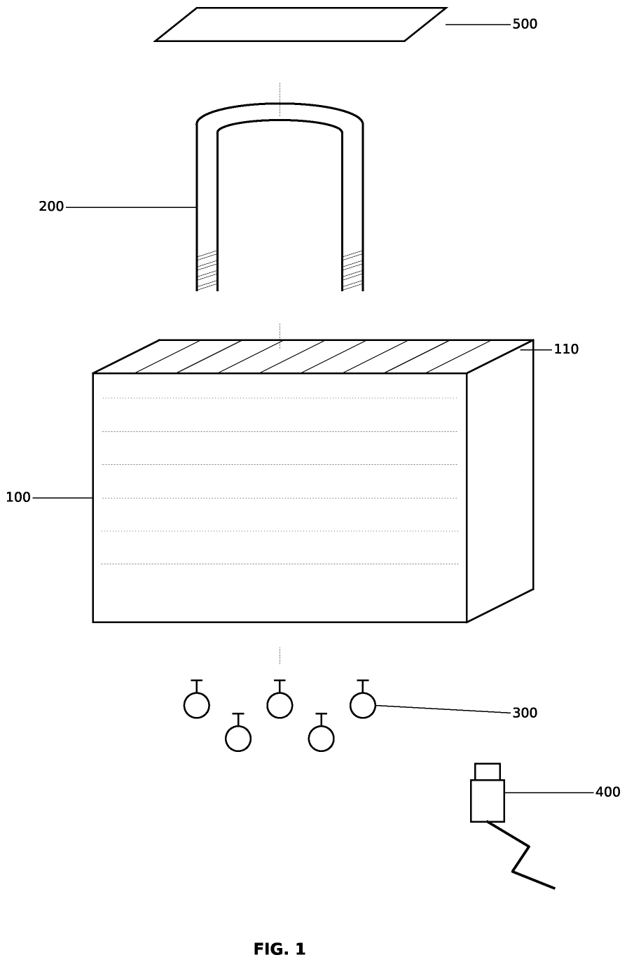

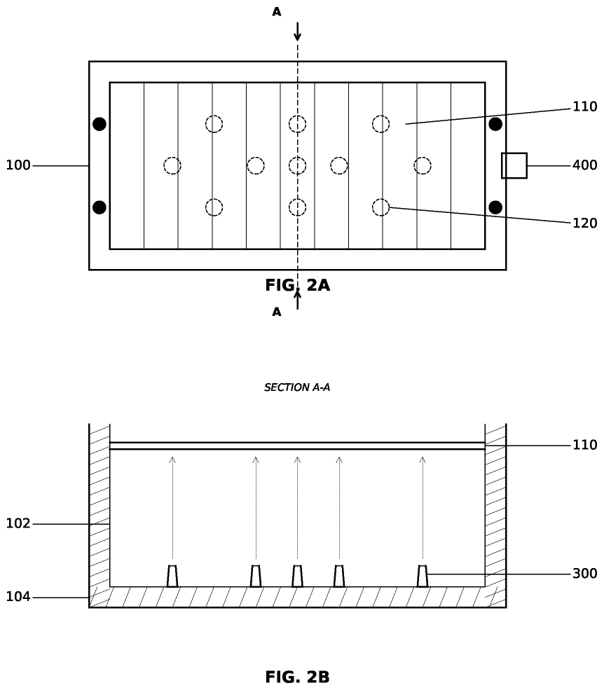

Referring now to the drawings, and initially to FIG. 1, there is shown an exploded perspective view of a portable footwear cleaning apparatus 10 according to an embodiment of the present invention. The apparatus 10 comprises a body 100, a handle 200, a plurality of nozzles 300, a water hose connector 400, and a cover 500.

The body 100 is a generally rectangular basin having an open upper end and defining an interior cavity 102 configured to receive a user's boot therein during a cleaning operation. In the illustrated embodiment, the body 100 has an overall length of approximately 609.60 mm (approximately 24.00 inches), a width of approximately 400 mm (approximately 15.75 inches), and a height of approximately 304.80 mm (approximately 12.00 inches). The body 100 has a wall thickness of approximately 32 mm (approximately 1.26 inches). In the preferred embodiment, the body 100 is formed from acrylonitrile butadiene styrene (ABS) by an injection molding process, although other suitable polymeric materials and manufacturing methods are contemplated, including but not limited to polypropylene, high-density polyethylene, polycarbonate, fiberglass-reinforced polymers, and rotational molding or thermoforming processes.

A scraping grate 110 is disposed within the interior cavity 102 at an upper region thereof. The grate 110 comprises a plurality of elongated bars or slats arranged in a spaced-apart, substantially parallel relationship, defining a plurality of elongated openings 112 therebetween. The grate 110 is configured to support the weight of a user's boot and to provide a textured surface against which the sole of the boot may be scraped to mechanically dislodge mud, clay, and other debris. The elongated openings 112 are dimensioned to permit dislodged debris and water to pass downwardly therethrough into the interior cavity 102.

A plurality of nozzle mounting apertures 120 are formed in a floor region 104 of the body 100, beneath the grate 110. In the illustrated embodiment, the apertures 120 include a first set of apertures having a diameter of approximately 20 mm (approximately 0.79 inches) and a second set of apertures having a diameter of approximately 27.20 mm (approximately 1.07 inches). The apertures 120 are arranged in a distributed pattern across the floor region 104 to provide substantially uniform water coverage across the underside of a boot positioned on the grate 110.

The plurality of nozzles 300 are received in and coupled to the nozzle mounting apertures 120. Each nozzle 300 is oriented to direct a jet of pressurized water in a generally upward direction through the elongated openings 112 of the grate 110 and against the sole and lower sidewall surfaces of the boot. In the illustrated embodiment, the nozzles 300 comprise a first row of nozzles 302 extending along a longitudinal axis of the body 100 and a second plurality of nozzles 304 arranged in a transverse row. The nozzles 300 may be fixed in orientation or may be adjustable to vary the angle of the water jets. Alternative embodiments may employ rotating nozzle heads, fan-spray nozzles, or nozzles of varying orifice diameters to achieve different spray patterns and pressures.

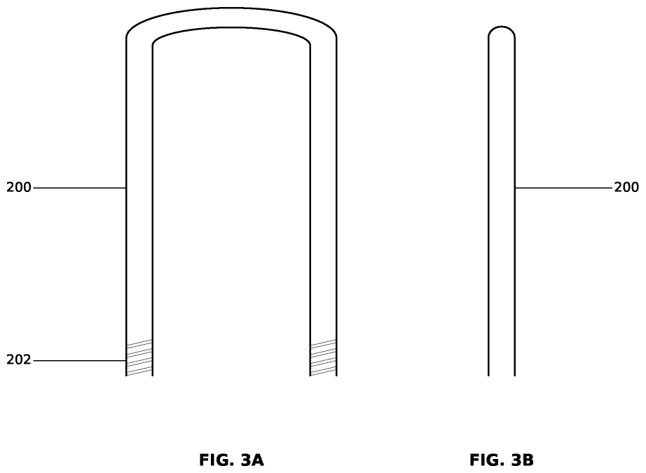

Referring now to FIG. 3A and FIG. 3B, the handle 200 is a generally U-shaped member configured to be received by the body 100 and to extend upwardly therefrom. The handle 200 has an overall width of approximately 400 mm (approximately 15.75 inches), an inner width of approximately 295 mm (approximately 11.61 inches), and a height of approximately 460 mm (approximately 18.11 inches). The handle 200 is formed from tubular stock having a diameter of approximately 25 mm (approximately 0.98 inches). In the preferred embodiment, the handle 200 is formed from injection-molded ABS, although other materials such as stainless steel, aluminum, or powder-coated steel tubing are contemplated. The handle 200 is configured to provide a stabilizing grip for a user standing on one foot while positioning the opposite boot within the apparatus 10 for cleaning. The lower terminal ends 202 of the handle 200 are received in corresponding receiving apertures (not separately numbered) formed in opposing side walls of the body 100. The handle 200 may be permanently affixed to the body 100 or may be removably engaged therewith to facilitate compact storage and transport.

The water hose connector 400 is disposed on an exterior surface of the body 100. In the illustrated embodiment, the connector 400 comprises a standard threaded fitting, such as a garden hose thread fitting, configured to receive a standard garden hose. A flow control mechanism 410, such as a lever valve or ball valve, is disposed between the connector 400 and a water distribution tube 420. Actuation of the flow control mechanism 410 permits or restricts the flow of pressurized water from the external hose through the water distribution tube 420 to the nozzles 300. In alternative embodiments, the flow control mechanism 410 may comprise a foot-actuated pedal, a push-button valve, or a pressure-responsive automatic valve.

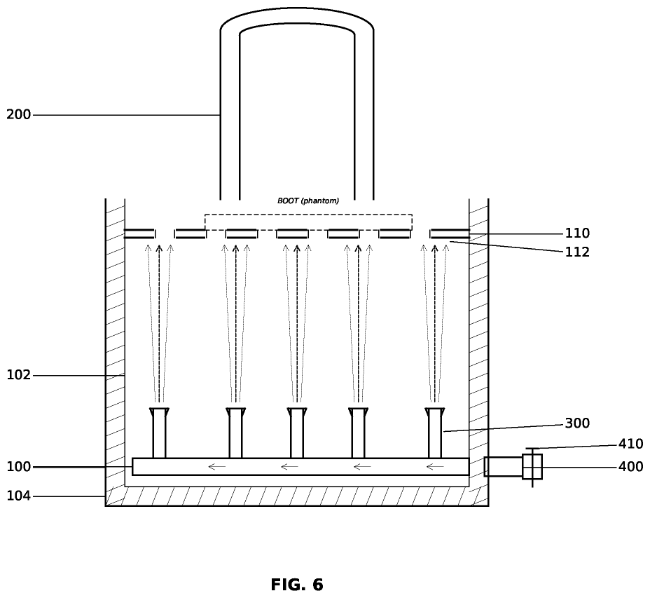

Referring now to FIG. 6, the water distribution tube 420 is disposed within the interior cavity 102 proximate the floor region 104 of the body 100. The tube 420 extends generally along the longitudinal axis of the body 100 and is fluidly connected at a first end thereof to the water hose connector 400 and the flow control mechanism 410 through a sidewall of the body 100. The tube 420 is fluidly connected at a plurality of branch points along the length thereof to respective ones of the plurality of nozzles 300. In the illustrated embodiment, pressurized water enters the tube 420 from the connector 400 and flows through the tube 420, being distributed to each of the nozzles 300 in turn. The tube 420 may be formed from a rigid polymeric material, such as PVC or ABS, or from a metallic material such as copper or stainless steel. In alternative embodiments, the tube 420 may comprise a manifold having a plurality of discrete outlet ports, each port being coupled to a respective nozzle 300.

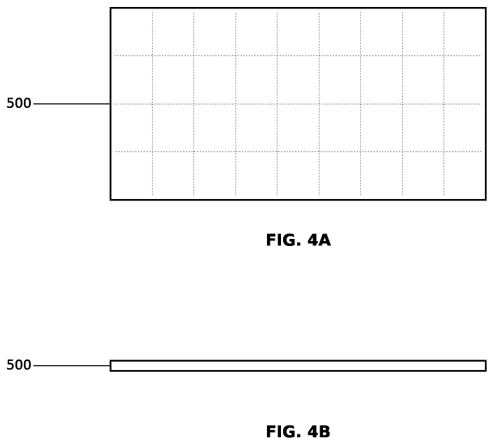

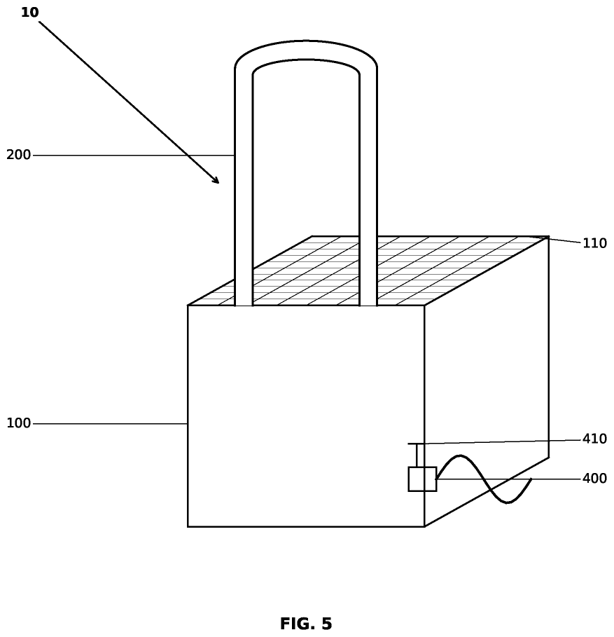

Referring to FIG. 4A and FIG. 4B, the cover 500 is a substantially planar member having a length of approximately 500 mm (approximately 19.69 inches), a width of approximately 270 mm (approximately 10.63 inches), and a thickness of approximately 2 mm (approximately 0.08 inches). The cover 500 is configured to be removably positioned over the open upper end of the body 100 when the apparatus 10 is not in use, thereby protecting the interior components, including the grate 110 and nozzles 300, from environmental contamination and damage during transport and storage. In the preferred embodiment, the cover 500 is formed from injection-molded ABS. Alternative embodiments may include a hinged cover, a snap-fit cover, or a cover formed from sheet metal or rubber.

In operation, a user first connects a standard garden hose to the water hose connector 400. The user then positions one boot on the grate 110, using the handle 200 for balance and stability. The user scrapes the sole of the boot against the grate 110 to mechanically remove loose mud and debris. The user then actuates the flow control mechanism 410, causing pressurized water to flow through the water distribution tube 420 and the nozzles 300 and upwardly against the sole and lower sidewall surfaces of the boot. By pressing the boot downwardly into the interior cavity 102, the user may adjust the depth of cleaning to address mud accumulation on higher portions of the boot. After cleaning, the flow control mechanism 410 is returned to the off position, the boot is removed, and the process is repeated for the opposite boot.

The interior cavity 102 collects the water and dislodged debris during the cleaning operation. In one embodiment, the body 100 includes a drain aperture (not shown) in the floor region 104 or a lower sidewall thereof, configured to allow collected water and debris to be discharged from the apparatus 10. In an alternative embodiment, the collected water and debris are retained within the interior cavity 102 and may be emptied by tilting or inverting the apparatus 10. In yet another embodiment, a removable debris tray or filter screen is disposed within the interior cavity 102 to capture larger debris while permitting water to pass through to the drain.

The apparatus 10 is configured to be lightweight and portable. The overall dimensions and weight of the assembled apparatus 10 permit it to be carried by hand or stored in the bed of a pickup truck, the cargo area of a utility van, or similar work vehicle. The use of ABS or comparable polymeric materials for the body 100, handle 200, and cover 500 contributes to a low overall weight while providing sufficient structural rigidity and impact resistance for field use.

Those skilled in the art will appreciate that various modifications and substitutions may be made to the described embodiments without departing from the scope of the invention. For example, the body 100 may be formed with integrated wheels or a carrying handle to further enhance portability. The grate 110 may comprise a mesh screen, a perforated plate, or a series of transverse bars rather than the longitudinal slats described above. The nozzles 300 may be coupled to an internal manifold for improved water distribution. An optional brush element may be disposed within the interior cavity 102 to provide additional mechanical cleaning action. A soap or cleaning solution dispenser may be integrated into the water supply pathway. The apparatus 10 may be scaled to accommodate footwear of varying sizes, from standard work boots to tall rubber wading boots. All such modifications are intended to fall within the scope of the appended claims.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. For brevity and/or clarity, well-known functions or constructions may not be described in detail herein.

The term “exemplary” is used herein to mean serving as an example, instance, or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner.

The terms “for example” and “such as” mean “by way of example and not of limitation.” The subject matter described herein is provided by way of illustration for the purposes of teaching, suggesting, and describing, and not limiting or restricting. Combinations and alternatives to the illustrated embodiments are contemplated, described herein, and set forth in the claims.

For convenience of discussion herein, when there is more than one of a component, that component may be referred to herein either collectively or singularly by the singular reference numeral unless expressly stated otherwise or the context clearly indicates otherwise. For example, components 38 (plural) or component 38 (singular) may be used unless a specific component is intended. Also, the singular forms “a,” “an,” and “the” are intended to include the plural forms as well, unless expressly stated otherwise or the context indicates otherwise.

It will be further understood that the terms “includes,” “comprises,” “including,” and/or “comprising” specify the presence of stated features, steps, operations, elements, and/or components, but do not preclude the presence or addition of one or more other features, steps, operations, elements, components, and/or groups thereof unless explicitly stated otherwise or the context clearly requires otherwise. The terms “includes,” “has” or “having” or variations in form thereof are intended to be inclusive in a manner similar to the term “comprises” as that term is interpreted when employed as a transitional word in a claim.

It will be understood that when a component is referred to as being “connected” or “coupled” to another component, it can be directly connected or coupled or coupled by one or more intervening components unless expressly stated otherwise or the context clearly indicates otherwise.

The term “and/or” includes any and all combinations of one or more of the associated listed items. As used herein, phrases such as “between X and Y” and “between about X and Y” should be interpreted to include X and Y unless expressly stated otherwise or the context clearly indicates otherwise.

Terms such as “about”, “approximately”, and “substantially” are relative terms and indicate that, although two values may not be identical, their difference is such that the apparatus or method still provides the indicated or desired result, or that the operation of a device or method is not adversely affected to the point where it cannot perform its intended purpose. As an example, and not as a limitation, if a height of “approximately X inches” is recited, a lower or higher height is still “approximately X inches” if the desired function can still be performed or the desired result can still be achieved.

While the terms vertical, horizontal, upper, lower, bottom, top and the like may be used herein, it is to be understood that these terms are used for ease in referencing the drawing and, unless otherwise indicated or required by context, does not denote a required orientation.

The different advantages and benefits disclosed and/or provided by the implementation(s) disclosed herein may be used individually or in combination with one, some or possibly even all of the other benefits. Furthermore, not every implementation, nor every component of an implementation, is necessarily required to obtain, or necessarily required to provide, one or more of the advantages and benefits of the implementation.

Conditional language, such as, among others, “can”, “could”, “might”, or “may”, unless specifically stated otherwise, or otherwise understood within the context as used, is generally intended to convey that certain embodiments preferably or optionally include certain features, elements and/or steps, while some other embodiments optionally do not include those certain features, elements and/or steps. Thus, such conditional language indicates, in general, that those features, elements and/or step may not be required for every implementation or embodiment.

Those skilled in the art will recognize many modifications may be made to the implementation(s) disclosed herein without departing from the scope or spirit of the claimed subject matter. The subject matter described above is provided by way of illustration only and should not be construed as limiting. Furthermore, the claimed subject matter is not limited to implementations that solve any or all disadvantages noted in any part of this disclosure. Various modifications and changes may be made to the subject matter described herein without following the exemplary embodiments and applications illustrated and described, and without departing from the spirit and scope of the following claims.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims.

Although the subject matter presented herein has been described in language specific to components used therein, it is to be understood that the appended claims are not necessarily limited to the specific component or characteristic thereof described herein. Rather, the specific components and characteristics thereof are disclosed as example forms of implementing the claims.

What is claimed is:

1. A portable footwear cleaning apparatus, comprising:
a body defining an interior cavity and having an open upper end, the body comprising a floor region and a plurality of side walls extending upwardly from the floor region;
a grate disposed within the interior cavity proximate the open upper end, the grate defining a plurality of openings therethrough and being configured to support a boot of a user thereon;
a plurality of nozzles disposed beneath the grate, each of the plurality of nozzles oriented to direct a jet of water in an upward direction through the plurality of openings of the grate;
a handle extending upwardly from the body and configured to provide a stabilizing grip for the user during a cleaning operation;
a water inlet disposed on the body and configured to be coupled to an external water supply;
a water distribution tube disposed within the interior cavity proximate the floor region, the water distribution tube being fluidly connected to the water inlet and to the plurality of nozzles; and
a flow control mechanism operably disposed between the water inlet and the water distribution tube, the flow control mechanism being actuatable between an open position permitting flow of water through the water distribution tube to the plurality of nozzles and a closed position restricting flow of water to the plurality of nozzles.

2. The apparatus of claim 1, wherein the body, the handle, and the grate are each formed from a polymeric material.

3. The apparatus of claim 2, wherein the polymeric material comprises acrylonitrile butadiene styrene (ABS).

4. The apparatus of claim 1, wherein the handle comprises a generally U-shaped member having two downwardly extending leg portions received in corresponding apertures formed in opposing side walls of the body.

5. The apparatus of claim 1, further comprising a cover removably positionable over the open upper end of the body to protect the interior cavity during transport and storage.

6. The apparatus of claim 1, wherein the water inlet comprises a garden hose thread fitting configured to receive a standard garden hose.

7. The apparatus of claim 1, wherein the plurality of nozzles are arranged in a distributed pattern across the floor region of the body to provide substantially uniform water coverage across an underside of the boot positioned on the grate.

8. The apparatus of claim 1, wherein the grate comprises a plurality of elongated bars arranged in a spaced-apart, substantially parallel relationship, defining a plurality of elongated openings therebetween configured to permit dislodged debris and water to pass downwardly therethrough.

9. The apparatus of claim 1, wherein the interior cavity is dimensioned to receive a boot pressed downwardly below the grate such that pressurized water from the plurality of nozzles contacts sidewall surfaces of the boot below a depth selected by the user.

10. The apparatus of claim 1, further comprising a drain aperture formed in at least one of the floor region and a lower portion of one of the plurality of side walls, the drain aperture configured to permit discharge of water and debris from the interior cavity.

11. The apparatus of claim 1, wherein the flow control mechanism comprises a lever valve.

12. The apparatus of claim 1, wherein the water distribution tube extends along a longitudinal axis of the body and is fluidly connected at a plurality of branch points to respective ones of the plurality of nozzles.

13. The apparatus of claim 1, wherein the body has a length of approximately 609.60 mm, a width of approximately 400 mm, and a height of approximately 304.80 mm.

14. A portable footwear cleaning apparatus, comprising:
a unitary basin body formed from a polymeric material and defining a rectangular interior cavity, the body having a floor region and a plurality of upstanding side walls;
a scraping grate disposed within the interior cavity at an upper region thereof, the scraping grate configured to support a boot thereon and having a textured upper surface adapted to mechanically dislodge debris from a sole of the boot when the sole is scraped thereacross;
a plurality of upwardly directed water jet nozzles mounted in the floor region beneath the scraping grate, the plurality of nozzles configured to project pressurized water upwardly through openings in the scraping grate and against the sole and lower sidewall surfaces of the boot;
a generally U-shaped handle extending upwardly from the body and configured to provide balance support to a user standing on one foot during use of the apparatus;
a water inlet fitting disposed on an exterior surface of the body and configured for connection to a garden hose;
a water distribution tube disposed within the interior cavity proximate the floor region, the water distribution tube fluidly connecting the water inlet fitting to the plurality of nozzles; and
a manually actuatable valve operably connected between the water inlet fitting and the water distribution tube.

15. The apparatus of claim 14, further comprising a substantially planar cover removably positionable over the interior cavity.

16. The apparatus of claim 14, wherein the handle is removably engaged with the body.

17. The apparatus of claim 14, wherein the plurality of nozzles comprises at least a first row of nozzles extending along a longitudinal axis of the body and a second plurality of nozzles arranged in a transverse row.

18. The apparatus of claim 14, wherein the water distribution tube comprises a manifold having a plurality of discrete outlet ports, each port being coupled to a respective one of the plurality of nozzles.

19. A method of cleaning a work boot at a job site, the method comprising:
providing a portable footwear cleaning apparatus comprising a body defining an interior cavity, a grate disposed at an upper region of the interior cavity, a plurality of upwardly directed nozzles disposed beneath the grate, a water distribution tube fluidly connecting a water inlet to the plurality of nozzles, a handle extending upwardly from the body, and the water inlet;
connecting an external water supply to the water inlet;
positioning the work boot on the grate;
scraping a sole of the work boot against the grate to mechanically dislodge debris therefrom;
actuating a flow control mechanism to direct pressurized water through the water distribution tube and the plurality of nozzles upwardly against the sole of the work boot; and
pressing the work boot downwardly into the interior cavity to a selected depth to expose sidewall surfaces of the work boot to the pressurized water.

20. The method of claim 19, further comprising gripping the handle with at least one hand to maintain balance during the positioning, scraping, and pressing steps.
